(19) United States
(12) Patent Application Publication
(10) Pub. No.: US 2023/0219136 A1
(43) Pub. Date: Jul. 13, 2023

(54) WASTE MAGNET REGENERATION METHOD

(71) Applicant: Emio-Yu Intellectual Property Consulting Co., Ltd., Hsinchu County (TW)

(72) Inventors: Ching-Ho YU, Hsinchu County (TW); Chih-Chieh MO, Hsinchu County (TW)

(21) Appl. No.: 17/807,866

(22) Filed: Jun. 20, 2022

(30) Foreign Application Priority Data
Jan. 10, 2022 (TW) 111101016

(51) Int. Cl. B22F 9/04; B22F 8/00; H01F 1/057; B22F 9/16

(52) U.S. Cl. CPC B22F 9/04; B22F 8/00; H01F 1/0577; H01F 1/0576; B22F 9/16; B22F 2009/044; B22F 2301/355; B22F 2301/155

(57) ABSTRACT

A waste magnet regeneration method includes the following steps. First, waste magnets and auxiliary alloys are provided, pre-treat the waste magnets, hydrogen decrepitating and sieving the waste magnets and the auxiliary alloys to form main alloy powders and auxiliary alloy powders. The main alloy powders and the auxiliary alloy powders are mixed in a predetermined ratio to form a mixture, and then the mixture is subjected to the jet mill pulverization, magnetic field alignment compacting, sintering and aging treatment to obtain a regenerated magnet.

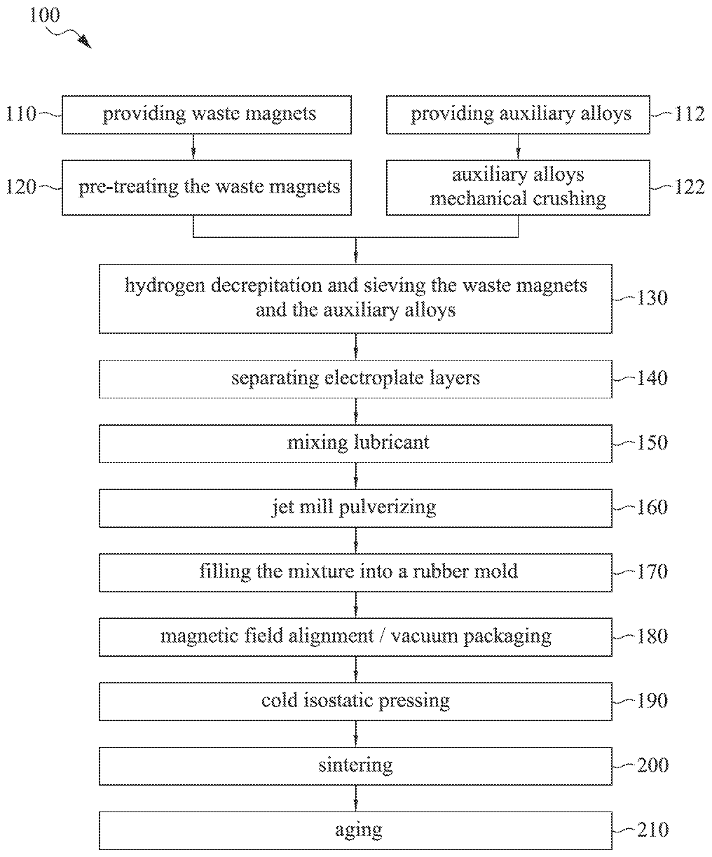

### RELATED APPLICATIONS

This application claims priority to Taiwan Application Serial Number 111101016, filed Jan. 10, 2022, the disclosures of which are incorporated herein by reference in their entireties.

### BACKGROUND

### Technical Field

The present disclosure relates to a waste magnet regeneration method. More particularly, the present disclosure relates to a NdFeB waste magnet regeneration method.

### Description of Related Art

With the advancement of science and technology, a lot of kinds of electronic and electrical equipment often need to use materials such as magnets. The rare earth magnets are a new star in the field of hard magnetic materials, and their excellent characteristics make them suitable for high-performance applications. The rare earth magnets quickly replace the conventional magnets and inspire people to continue to develop new applications thereof.

NdFeB (neodymium iron boron) permanent magnet material is an intermetallic compound formed by rare earth metal elements such as neodymium and iron. The NdFeB permanent magnet material has excellent magnetic properties and is one of the most important functional materials with rare earth materials. In recent years, the materials of the NdFeB permanent magnet are becoming more and more extensive, and the application field thereof has expanded from the military field such as the aviation, aerospace, navigation and weapons to more extensive high-tech civilian field such as the instrument, meter, energy, transportation, medical equipment, electronic power and communication.

With the development of NdFeB magnets, the types of NdFeB magnets are also more abundant and the specifications thereof are also increased. Due to the increasing total amount and types of rare earths used, there is a need to properly recycle the waste of NdFeB magnets so as to contribute to the sustainable development of NdFeB magnets, reduce resource consumption, and thus reduce damage to the environmental.

### SUMMARY

One aspect of the present disclosure is a waste magnet regeneration method to recycle various magnet waste materials for further producing desired magnet products.

According to some embodiments of the present disclosure, a waste magnet regeneration method includes providing waste magnets and auxiliary alloys, pre-treating the waste magnets, hydrogen decrepitating and sieving the waste magnets and the auxiliary alloys to form main alloy powders and auxiliary alloy powders and processing the mixture with a jet mill pulverization treatment, a magnetic field alignment compacting treatment, a sintering treatment and an aging treatment to produce a regenerated magnet. The main alloy powders and the auxiliary alloy powders are mixed to form the mixture according to a weight ratio between 90:10-99:1. The chemical compositions of the auxiliary alloys are Rₐ(Co,Fe)_{b}(Cu,Al,Ga)_{c}, wherein R is a rare earth element comprising lanthanum (La), cerium (Ce), praseodymium (Pr), neodymium (Nd), gadolinium (Gd), terbium (Tb), dysprosium (Dy), holmium (Ho) or a combination thereof, wherein 70 wt %≤a≤98 wt %, 0.1 wt %≤b≤30 wt %, and 0.1 wt %≤c≤30 wt %.

In some embodiments, the chemical compositions of the auxiliary alloys are (Nd₈₀Pr₂₀)₉₀(Co₂₅Fe₇₅)₇Cu₁Al₂.

In some embodiments, a weight ratio of the main alloy powders and the auxiliary alloy powders is about 97:3.

In some embodiments, the chemical compositions of the auxiliary alloys are (Nd₄₀Pr₅₀Dy₁₀)₈₅(Co₄₀Fe₆₀)₉Ga₆.

In some embodiments, a weight ratio of the main alloy powders and the auxiliary alloy powders is about 98:2.

In some embodiments, the chemical compositions of the auxiliary alloys are (La₁₀Ce₁₅Nd₆₅Pr₁₀)₈₅(Co₁₀Fe₉₀)₈Al₇.

In some embodiments, a weight ratio of the main alloy powders and the auxiliary alloy powders is about 97.5:2.5.

In some embodiments, the step of pre-treating the waste magnets includes screening the waste magnets, demagnetizing the waste magnets, removing organics from the waste magnets, cleaning the waste magnets and mechanically crushing the waste magnets to expose inner surfaces of the waste magnets.

In some embodiments, the step of hydrogen decrepitating and sieving the waste magnets further includes separating electroplate layers from the waste magnets to obtain the main alloy powders.

In some embodiments, the steps of removing organics from the waste magnets and cleaning the waste magnets further comprise soaking paint stripper, ultrasonic washing, ultrasonic degreasing, pickling and drying process.

Hence, the waste magnet regeneration method of the present invention can conveniently recycle the waste magnets. In addition, after adding suitable auxiliary alloys, the waste magnets can be crushed by hydrogen decrepitating, sieving, jet mill pulverization, magnetic field alignment compacting treatment, cold isostatic pressing, sintering treatment and aging treatment, the waste magnet regeneration method of the present invention can make the regenerated magnets to reach the same magnetic characteristics as the original magnets, without the need to extract rare metals again, thereby improving the recycling of the neodymium iron boron magnets, and reducing resource consumption and environmental damage.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

The single FIGURE illustrates a flow chart of a waste magnet regeneration method according to one embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The FIGURE illustrates a flow chart of a waste magnet regeneration method according to one embodiment of the present invention. As shown in the FIGURE, a waste magnet regeneration method 100 includes the following steps. First, in step 110, waste magnets are provided. In step 112, auxiliary alloys are provided. Subsequently, in step 120, the waste magnets are pre-treated, and the pre-treatment of the waste magnets includes the following steps of screening the waste magnets to remove non-magnetic material, demagnetizing the waste magnets, removing organics from the waste magnets, cleaning the surface of the waste magnets, and then mechanically crushing the waste magnets to a plurality of small particles of the waste magnets so as to expose fresh inner surfaces of the waste magnets.

In some embodiments, the steps of removing organics from the waste magnets and cleaning the waste magnets include, but not limited to, the following processes such as soaking paint stripper, ultrasonic washing, ultrasonic degreasing, pickling and drying process.

Subsequently, in step 130, the particles of the waste magnets are hydrogen decrepitated. In some embodiments, the particles of the waste magnets are hydrogen decrepitated by the following steps of hydrogen absorption at room temperature for 2 hours, and dehydrogenation at a high temperature of 570 degrees Celsius for about 7 hours, so as to crush the waste magnets and the auxiliary alloys at the same time, but is not limited to this.

Then, in step 140, the electroplate layers are separated from the waste magnets to screen off the electroplate layers peeled off from the surfaces of the waste magnets so as to remove impurities such as the electroplate layers.

In step 150, a lubricant is mixed, such as 0.1% lubricant is mixed.

In step 160, the sieved particles of the waste magnets and auxiliary alloys are further processed by a jet mill pulverization process, for example, the waste magnets and auxiliary alloys are jet mill pulverized under nitrogen protection to further pulverize the particles of the waste magnets and the auxiliary alloys to be as main alloy powders and auxiliary alloy powders. In addition, the main alloy powders and the auxiliary alloy powders are further mixed together to form a mixture, and the weight ratio thereof is between 90:10-99:1.

In step 170, the mixture is filled into a rubber mold, for example, in a nitrogen chamber.

Then, in the step 180, a magnetic field alignment compacting treatment is performed, such as a pulse magnetic field alignment treatment is performed and then a vacuum packaging is performed.

In step 190, a cold isostatic pressing (CIP) is performed. For example, after the mixture is wrapped with a plastic rubber mold, the same is placed into a cavity filled with medium liquid and is compressed by high-pressure liquid formation to mold the powders. In some embodiments, the green compact of the molded mixture can be demagnetized by the pulse magnetic field alignment.

In step 200, a sintering treatment process is performed. The green compact of the molded mixture is demolded in a nitrogen chamber and is then performed by the sintering treatment. In some embodiments, the sintering treatment is performed under vacuum at 1060 degrees Celsius to 1080 degrees Celsius for about 5 hours.

Subsequently, in step 210, the magnet after the sintering treatment is subjected to an aging treatment in a vacuum state, for example, at 470 degrees Celsius about 4 hours, but is not limited to this. In addition, in some embodiments, the processes from step 130 to step 190 preferably adopt oxygen isolation processes, but not limited to this.

In some embodiments, the chemical compositions of the auxiliary alloys are

Rₐ(Co,Fe)_{b}(Cu,Al,Ga)_{c}

wherein R is a rare earth element comprising lanthanum (La), cerium (Ce), praseodymium (Pr), neodymium (Nd), gadolinium (Gd), terbium (Tb), dysprosium (Dy), holmium (Ho) or a combination thereof, and 70 wt %≤a≤98 wt %, 0.1 wt %≤b≤30 wt %, and 0.1 wt %≤c≤30 wt %.

The following embodiments are some exemplary examples such as the regeneration of the NdFeB magnets of the wind turbines, the regeneration of the NdFeB magnets of the vehicle generators and the regeneration of the NdFeB magnets of the voice coil motors (VCM) of the hard disk drives (HDD) to describe the magnetic properties of the regenerated NdFeB magnets manufactured by the waste magnet regeneration method of the present invention.

### Exemplary Embodiment I: NdFeB Magnet Regeneration for Wind Turbines

First, 18000 grams waste magnets (original N40H waste magnets, i.e. BHmax=37-41MGOe/iHc>17 kOe) of wind turbines and 556 grams auxiliary alloys are provided. In addition, the chemical formula of the auxiliary alloys is:

(Nd₈₀Pr₂₀)₉₀(Co₂₅Fe₇₅)₇Cu₁Al₂

The weight ratio of the main alloy powders and the auxiliary alloy powders is about 97:3. The magnetic characteristic of the regenerated magnet manufactured by the waste magnet regeneration method 100 is shown in Table I.

TABLE I

| | Density(g/cm3) | Br(kG) | iHc(kOe) | BHmax(MGOe) |
|---|---|---|---|---|
| waste magnets | 7.45 | 12.45 | 18.25 | 39.64 |
| of wind | | | | |
| turbines | | | | |
| regenerated | 7.47 | 12.68 | 17.55 | 40.12 |
| magnet | | | | |

wherein Br: residual induction
iHc: intrinsic coercive force
BHmax: maximum energy product

The BHmax of the regenerated magnet manufactured by the waste magnet regeneration method 100 is equal to 40.12 MGOe, and iHc is equal to 17.55 kOe (H grade). Therefore, the magnetic characteristics of the regenerated magnet can be restored to the original N40H grade magnet. That is to say, the original 18000 grams waste magnets of the wind turbines can manufacture 17271 grams regenerated magnet (after deducting auxiliary alloy 556 grams), and the magnetic characteristics can reach to the N40H grade. The waste magnet regeneration method can regenerate about 96% waste magnets of the wind turbines by adding appropriate auxiliary alloy components and performing corresponding process treatment, the regeneration ratio of waste magnets can be effectively increased, and the regenerated waste magnets can also reach the required magnetic characteristics. Therefore, the recycling of the NdFeB magnets for wind turbines is improved, resource consumption is reduced, and environmental hazards are reduced.

### Exemplary Embodiment II: NdFeB Magnet Regeneration for Vehicle Generators

23250 grams waste magnets (original EH grade waste magnets, i.e. the magnets can be used in an operating environment up to 200° C.) of the vehicle generators and 475 grams auxiliary alloys are provided. In addition, the chemical formula of the auxiliary alloys is:

(Nd₄₀Pr₅₀Dy₁₀)₈₅(Co₄₀Fe₆₀)₉Ga₆

The weight ratio of the main alloy powders and the auxiliary alloy powders is about 98:2. The magnetic characteristic of the regenerated magnet manufactured by the waste magnet regeneration method 100 is shown in Table

TABLE II

| | Density(g/cm3) | Br(kG) | iHc(kOe) | BHmax(MGOe) |
|---|---|---|---|---|
| waste magnets | 7.62 | 11.34 | 31.3 | 32.15 |
| of vehicle | | | | |
| generators | | | | |
| regenerated | 7.58 | 11.76 | 30.8 | 31.66 |
| magnet | | | | |

wherein Br: residual induction
iHc: intrinsic coercive force
BHmax: maximum energy product

The BHmax of the regenerated magnet manufactured by the waste magnet regeneration method 100 is equal to 31.66 MGOe, and iHc is equal to 30.8 kOe (EH grade). Therefore, the magnetic characteristics of the regenerated magnet can be restored to the original EH grade magnet. That is to say, the original 23250 grams waste magnets of the vehicle generators can manufacture 20237 grams regenerated magnet (after deducting auxiliary alloy 475 grams), and the magnetic characteristics can reach to the EH grade. The waste magnet regeneration method can regenerate about 87% waste magnets of the vehicle generators by adding appropriate auxiliary alloy components and performing corresponding process treatment, the regeneration ratio of waste magnets can be effectively increased, and the regenerated waste magnets can also reach the required magnetic characteristics. Therefore, the recycling of the NdFeB magnets for vehicle generators is improved, resource consumption is reduced, and environmental hazards are reduced.

### Exemplary Embodiment III: NdFeB Magnet Regeneration for Voice Coil Motors of Hard Disk Drives

34450 grams waste magnets (original N50M waste magnets, i.e. BHmax=47-51MGOe/iHc>14 kOe, and original N45H waste magnets, i.e. BHmax=42-46MGOe/iHc>17 kOe) of wind turbines, and 883 grams auxiliary alloys are provided. In addition, the chemical formula of the auxiliary alloys is:

(La₁₀Ce₁₅Nd₆₅Pr₁₀)₈₅(Co₁₀Fe₉₀)₈Al₇

The weight ratio of the main alloy powders and the auxiliary alloy powders is about 97.5:2.5. The magnetic characteristic of the regenerated magnet manufactured by the waste magnet regeneration method 100 is shown in Table III.

TABLE III

| | Density(g/cm3) | Br(kG) | iHc(kOe) | BHmax(MGOe) |
|---|---|---|---|---|
| waste magnets | 7.5- | 13.44- | 14.93- | 45.10- |
| of voice coil | 7.51 | 14.00 | 17.89 | 49.00 |
| motors of hard | | | | |
| disk drives | | | | |
| regenerated | 7.51 | 13.73 | 16.33 | 47.21 |
| magnet | | | | |

wherein Br: residual induction
iHc: intrinsic coercive force
BHmax: maximum energy product

The BHmax of the regenerated magnet manufactured by the waste magnet regeneration method 100 is equal to 47.21 MGOe, and iHc is equal to 16.33 kOe (N48M grade). Therefore, the magnetic characteristics of the regenerated magnet can be restored to the intermediate value of the original N48M grade magnet. That is to say, the original 34450 grams waste magnets of the voice coil motors of hard disk drives can manufacture 22097 grams regenerated magnet (after deducting auxiliary alloy 883 grams), and the magnetic characteristics can reach to the intermediate value of the N48M grade. The waste magnet regeneration method can regenerate about 64.1% waste magnets of the voice coil motors of hard disk drives by adding appropriate auxiliary alloy components and performing corresponding process treatment, the regeneration ratio of waste magnets can be effectively increased, and the regenerated waste magnets can also reach the required magnetic characteristics. Therefore, the recycling of the NdFeB magnets for the voice coil motors of hard disk drives is improved, resource consumption is reduced, and environmental hazards are reduced.

Accordingly, the waste magnet regeneration method of the present invention can conveniently recycle the waste magnets. In addition, after adding suitable auxiliary alloys, the waste magnets can be crushed by hydrogen decrepitating, sieving, jet mill pulverization, magnetic field alignment, cold isostatic pressing, sintering treatment and aging treatment, the waste magnet regeneration method of the present invention can make the regenerated magnets to reach the same magnetic characteristics as the original magnets, without the need to extract rare metals again, thereby improving the recycling of the neodymium iron boron magnets, and reducing resource consumption and environmental damage.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A waste magnet regeneration method, comprising:
providing waste magnets and auxiliary alloys;
pre-treating the waste magnets;
hydrogen decrepitating and sieving the waste magnets and the auxiliary alloys to form main alloy powders and auxiliary alloy powders, wherein the main alloy powders and the auxiliary alloy powders are mixed to form a mixture according to a weight ratio between 90:10-99:1; and
processing the mixture with a jet mill pulverization treatment, a magnetic field alignment compacting treatment, a sintering treatment and an aging treatment to produce a regenerated magnet, wherein chemical compositions of the auxiliary alloys are Rₐ(Co,Fe)_{b}(Cu,Al,Ga)_{c}, wherein R is a rare earth element comprising lanthanum (La), cerium (Ce), praseodymium (Pr), neodymium (Nd), gadolinium (Gd), terbium (Tb), dysprosium (Dy), holmium (Ho) or a combination thereof, wherein 70 wt %≤a≤98 wt %, 0.1 wt %≤b≤30 wt %, and 0.1 wt %≤c≤30 wt %.

2. The waste magnet regeneration method of claim 1, wherein the chemical compositions of the auxiliary alloys are (Nd₈₀Pr₂₀)₉₀(Co₂₅Fe₇₅)₇Cu₁Al₂.

3. The waste magnet regeneration method of claim 2, wherein a weight ratio of the main alloy powders and the auxiliary alloy powders is about 97:3.

4. The waste magnet regeneration method of claim 1, wherein the chemical compositions of the auxiliary alloys are (Nd₄₀Pr₅₀Dy₁₀)₈₅(Co₄₀Fe₆₀)₉Ga₆.

5. The waste magnet regeneration method of claim 4, wherein a weight ratio of the main alloy powders and the auxiliary alloy powders is about 98:2.

6. The waste magnet regeneration method of claim 1, wherein the chemical compositions of the auxiliary alloys are (La₁₀Ce₁₅Nd₆₅Pr₁₀)₈₅(Co₁₀Fe₉₀)₈Al₇.

7. The waste magnet regeneration method of claim 6, wherein a weight ratio of the main alloy powders and the auxiliary alloy powders is about 97.5:2.5.

8. The waste magnet regeneration method of claim 1, wherein the step of pre-treating the waste magnets comprises:
screening the waste magnets;
demagnetizing the waste magnets;
removing organics from the waste magnets;
cleaning the waste magnets; and
mechanically crushing the waste magnets to expose inner surfaces of the waste magnets.

9. The waste magnet regeneration method of claim 8, wherein the step of hydrogen decrepitating and sieving the waste magnets further comprises separating electroplate layers from the waste magnets to obtain the main alloy powders.

10. The waste magnet regeneration method of claim 9, wherein the steps of removing organics from the waste magnets and cleaning the waste magnets further comprise soaking paint stripper, ultrasonic washing, ultrasonic degreasing, pickling and drying process.
